(19) United States
(12) Patent Application Publication
(10) Pub. No.: US 2018/0096289 A1
(43) Pub. Date: Apr. 5, 2018

(54) TRAILER LOADING USING A VEHICLE GATEWAY

(71) Applicant: Dell Products L.P., Round Rock, TX (US)

(72) Inventors: Kevin Terwilliger, Austin, TX (US); Andrew Tosh, Cedar Park, TX (US); Jefferson Walter Wirtz, Round Rock, TX (US); Rex Bryan, Round Rock, TX (US)

(73) Assignee: Dell Products L.P., Round Rock, TX (US)

(21) Appl. No.: 15/286,499

(22) Filed: Oct. 5, 2016

(51) Int. Cl. G06Q 10/08; H04L 29/08; G06Q 50/28; B60W 30/10; B60W 40/08; B60R 11/02

(52) U.S. Cl. CPC G06Q 10/083; H04L 67/12; B60R 11/0264; B60W 30/10; B60W 40/08; G06Q 50/28

(57) ABSTRACT

Electronic components may be integrated in objects used by the trucking industry, such as truck, trailer, cargo, and loading bay. These objects may then communicate with each other and with a gateway device to transmit or receive data or commands. The gateway may be configured to attach to the truck, such as by securing to the truck frame or securing to an interior of the truck cab. The gateway may couple to one or more input devices, and receive sensor data through the one or more input devices. The gateway may execute steps that allow the gateway to monitor cargo loads in a vehicle and determine an arrangement for the cargo to satisfy certain criteria or optimize loading.

### CROSS-REFERENCE TO RELATED PATENT APPLICATIONS

This application is related by subject matter to U.S. patent application Ser. No. 15/______ [[Atty. Dkt. No. DELL.P0081US]] filed on Oct. 5, 2016 and entitled, “Trailer Identification, Inspection, and Verification using a Vehicle Gateway,” to U.S. patent application Ser. No. 15/______ [[Atty. Dkt. No. DELL.P0082US]] filed on Oct. 5, 2016 and entitled, “Cargo Geofencing using a Vehicle Gateway,” to U.S. patent application Ser. No. 15/______ [[Atty. Dkt. No. DELL.P0084US]] filed on Oct. 5, 2016 and entitled, “Truck Safety Zone Using a Vehicle Gateway,” to U.S. patent application Ser. No. 15/______ [[Atty. Dkt. No. DELL.P0085US]] filed on Oct. 5, 2016 and entitled, “Vehicle Firmware Update using a Vehicle Gateway,” and to U.S. patent application Ser. No. 15/______ [[Atty. Dkt. No. DELL.P0086US]] filed on Oct. 5, 2016 and entitled, “Determining a Driver Condition using a Vehicle Gateway,” the disclosures of which are each incorporated by reference herein.

### FIELD OF THE DISCLOSURE

The instant disclosure relates to electronic devices. More specifically, portions of this disclosure relate to integration of electronic devices in the operation of vehicles.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have garnered ubiquitous use in certain fields, such as financial transactions, data storage, and the like. This is due, in part, to the ability of information handling systems to handle large numbers of tasks with significantly fewer errors than other techniques. Information handling systems can be designed or programmed specifically to perform certain functions, and thus take advantage of further speed advantages from this customization. However, there are certain industries and fields that have historically not modernized to take advantage of the capabilities of information handling systems, or to not fully take advantage of such systems by having specially-designed components. One such industry is the trucking industry. Tractor trailers are responsible for a significant amount of merchandise movement throughout the country and continent, and typically also a part of every merchandise's journey. The population is continuously growing, and also the demand for merchandise. Thus, the trucking industry is also continuously growing. The number of tractor trailers on the road and the number of deliveries by each tractor trailer are continuing to increase. Yet, there has been little modernization of the trucking industry.

However, lack of modernization and implementation of information handling systems has caused many problems with operation of a fleet of tractor trailers. As one example, there is little to no monitoring of truck driver health, such as enforcement of sleep requirements or monitoring of other health issues, which can result in unsafe driving and collisions involving tractor trailers. As another example, fuel efficiency is critical to profit margins of the tractor trailers, and yet there is little or no monitoring of engine operating conditions. As yet another example, the distribution of freight within a tractor trailer can impact operational efficiency and driving stability, and yet there is no optimization of freight arrangements within the tractor trailer. As a further example, the only monitoring of tractor trailers is through GPS devices with limited functionality. Thus drivers often pick up the wrong trailer in a shipping yard, which leads to lost or misdirected merchandise and lost profit.

### SUMMARY

Electronic components may be integrated in objects used by the trucking industry, such as truck, trailer, cargo, and loading bay. These objects may then communicate with each other and/or with a gateway device to transmit or receive data or commands. The communications between devices may include relay of information from the objects to a remote server through the Internet. Either the gateway device or the remote server may use the relayed information to verify certain information or provide instruction to vehicle operators to improve efficiency and accuracy of the trucking industry. For example, by verifying trailers assigned to trucks have been picked up by the correct trucks, a reduction in misdirected or lost merchandise is obtained. As another example, by ensuring inspection checklists are completed, costly malfunctions may be avoided and profit margins increased. As a further example, by monitoring the health of the user, the user may feel more secure and happy with their job and thus drivers may be retained longer.

A vehicle gateway, or just “gateway,” may be configured to attach to the truck, such as by securing to the truck frame or securing to an interior of the truck cab. The gateway may receive power from the vehicle power system and/or an independent power supply, such as a battery or solar cell. Although vehicle gateways are described as part of a vehicle, the gateways may be used in areas outside of the vehicle such as in loading bays, parking areas, or the like. The gateway may couple to one or more input devices to receive sensor data. The gateway may also be configured, for some of the input devices, to transmit commands to alter operation of certain components onboard or off-board the vehicle. For example, one input device may be a communications radio, such as a Wi-Fi radio, Bluetooth radio, cellular communication radio, or other short-range or long-range communication radio. Through the communications radio the gateway may receive sensor data, for example, from sensors located throughout the trailer or nearby the trailer (e.g., in range of the communications radio). For example, the sensors may be attached to the trailer. In another example, the sensors may be in nearby containers and/or in nearby vehicles. As another example, an input device may be an interface for connecting to an engine computer, such as an OBDII port. The gateway may process raw data received from the electronic components, store the raw or processed data, and/or relay the raw or processed data to a remote server.

The integration of electronic components in the trucking industry makes available new applications for these electronic components and improves operations and efficiency in the trucking industry. For example, beacon devices, or just “beacons,” may be integrated with trailers and a vehicle gateway may activate the beacon to determine the trailer identification and verify the correct trailer is being picked up by the vehicle. The beacons may include a memory circuit with stored information and a communications circuit for communicating the stored information to a gateway. As another example, the vehicle gateway may communicate with biometric systems, including mobile devices such as smart watches and mobile phones, to collect information regarding driver behaviors, such as sleep patterns, to assess a condition of the driver. As a further example, electronic sensors may be integrated throughout a tractor trailer and communicate with the vehicle gateway to monitor and/or optimize loading of cargo into the tractor trailer. As yet another example, beacons may be attached to cargo containers and the beacons linked with contents of the cargo such that a vehicle gateway may determine conflicts that may exist between different cargo contents that may create a hazardous condition. As another example, vehicle gateways may communicate with other vehicle gateways to determine and/or optimize formation of vehicle platoons and provide information that ensures safety of nearby vehicles. As a further example, a vehicle gateway may monitor driving conditions and/or a planned truck route to determine when a different engine firmware may provide better fuel efficiency or other benefits and then update the engine firmware with an appropriate firmware.

The vehicle gateway may operate as a data collection device and/or a data processing device. As described throughout, the gateway may receive data from input devices that communicate with beacons, sensors, mobile devices, or other components. This data may be forwarded through, for example, cellular communications systems to cloud-based server that process the data. A driver or other user may then access a dashboard presenting the information and/or alerts based on the information through a web-based interface. Further, the driver or other user may issue commands to the vehicle gateway that are relayed to components in communications with the gateway. The commands may include, for example, remotely updating an engine firmware, changing a vehicle route, establishing new stops on the route, providing messages to a driver, or placing operating restrictions on the vehicle. Cloud-based servers may also automate certain functions by performing monitoring of the received data and sending commands to the gateway when certain conditions are satisfied. Although the gateway may communicate with cloud-based server, the gateway may also independently perform some or all of these functions. For example, a driver or user may access the gateway through a mobile device or nearby computer to access data stored on the gateway. Further, the gateway may process the data and analyze the data to determine if certain conditions are satisfied and take action, such as by transmitting alerts to the driver or another user.

According to embodiments, an information handling system may include a first plurality of sensors positioned throughout a vehicle. For example, the first plurality of sensors may be configured to monitor a load at a corresponding plurality of locations within an enclosed space of a vehicle. The information handling system may also include a vehicle gateway configured to attach to the vehicle and to communicate with the first plurality of sensors, and optionally other sensors and devices. The vehicle gateway may be configured to perform steps related to monitoring conditions in and around the vehicle using the first plurality of sensors. In certain embodiments, the gateway may perform steps of receiving a first plurality of load values from the first plurality of sensors corresponding to the plurality of locations, and determining an arrangement for a plurality of freight pieces within the vehicle based, at least in part, on the received first plurality of load values.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a perspective view of a vehicle illustrating an installed gateway for communicating with electronic components in or around the vehicle according to one embodiment of the disclosure.

FIG. 2 is a perspective view of a vehicle illustrating an installed gateway for communicating with sensors in and around a tractor trailer attached to the vehicle according to one embodiment of the disclosure.

FIG. 3 is a perspective view of a vehicle illustrating an installed gateway for communicating with electronic components in and around the vehicle and in and around a loading bay according to one embodiment of the disclosure.

FIG. 4 is a perspective view of a vehicle illustrating an installed gateway for communicating with electronic components in cargo and around a loading bay or other nearby vehicles according to one embodiment of the disclosure.

FIG. 5 is a block diagram illustrating communications paths around a vehicle gateway for communicating with electronic components according to one embodiment of the disclosure.

FIG. 6 is a flow chart illustrating an example method for load balancing in a tractor trailer with a vehicle gateway according to one embodiment of the disclosure.

FIG. 7 is a flow chart illustrating an example method for load balancing in a tractor trailer while taking into account vehicle route with drop-offs and pick-ups according to one embodiment of the disclosure.

FIG. 8 is a perspective view of a vehicle illustrating an installed gateway for communicating with electronic components in and around the vehicle and in and around a loading bay according to one embodiment of the disclosure.

FIG. 9 is a flow chart illustrating an example method of guiding a user in the loading of a tractor trailer using an interface to the vehicle gateway according to one embodiment of the disclosure.

### DETAILED DESCRIPTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be adapted to provide services to vehicles, to fleets of vehicles, and/or to drivers of vehicles. Such information handling systems may be particularly useful in the trucking industry, where historically little modernization has occurred. Some hardware and software components for such information handling systems are described in further detail below. One such hardware component is a vehicle gateway that is configured to attached to a vehicle, such as a tractor pulling a trailer. The vehicle gateway may communicate with electronic components in and around the vehicle through wired and wireless communications paths. The gateway may also execute software components for processing the data, triggering alerts, making recommendations, and/or adjusting operation of the vehicle.

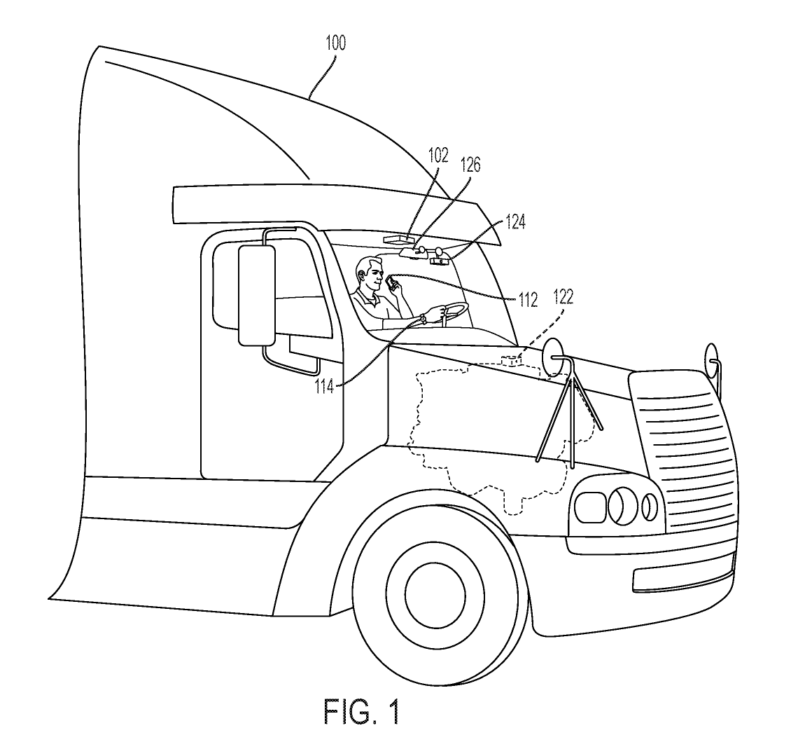

FIG. 1 is a perspective view of a vehicle illustrating an installed gateway for communicating with electronic components in or around the vehicle according to one embodiment of the disclosure. A vehicle 100 may be a truck with tractor trailer, as shown, or another kind of vehicle, such as a car or sport-utility vehicle (SUV), or another transportation device, such as a cargo boat or aircraft. A gateway 102 may be configured to attach to and attached to the vehicle 100, such as by a screw, bolt, Velcro, adhesive, or other fixing means that affixes the gateway 102 to a component of the vehicle 100, such as a frame or an interior of a cab of the vehicle 100. In some embodiments, the gateway 102 may be a separate component inside the vehicle 100. In some embodiments, the gateway 102 may be integrated with another component attached to the vehicle 100, such as an in-dash display or radio. The gateway 102 may be connected to power or communications systems of the vehicle 100. For example, the gateway 102 may be powered from a 12 Volt direct-current (DC) bus operated by a battery in the vehicle 100. Additionally or alternatively, the gateway 102 may include a back-up or other separated power system to operate the gateway 102 when the vehicle 100 is turned off or when the vehicle 100 malfunctions.

The gateway 102 may communicate with electronic components in and around the vehicle 100 through input devices coupled to the gateway 102. For example, a driver may have a mobile phone 112, a smart watch 114, and/or other electronic devices, such as a tablet computer, a laptop computer, a television, a radio, a GPS device, etc. These mobile devices 112 and 114 may communicate with the gateway 102 through an input device such as, for example, a Bluetooth radio, a Wi-Fi radio, a near field communications (NFC) radio, or other short-range communications radio. As another example, an engine of the vehicle 100 may have an engine computer 122. The gateway 102 may include an input device configured to communicate with the engine computer 122, such as an ODBII port. The gateway 102 may be further coupled to other electronic devices, such as a road-facing camera 124 and/or an eye-tracking system 126, by either wireless or wired connections similar to that described in the examples above. The eye-tracking system 126 may be used to monitor eye movement of a driver, which can provide information regarding, for example, the driver's alertness.

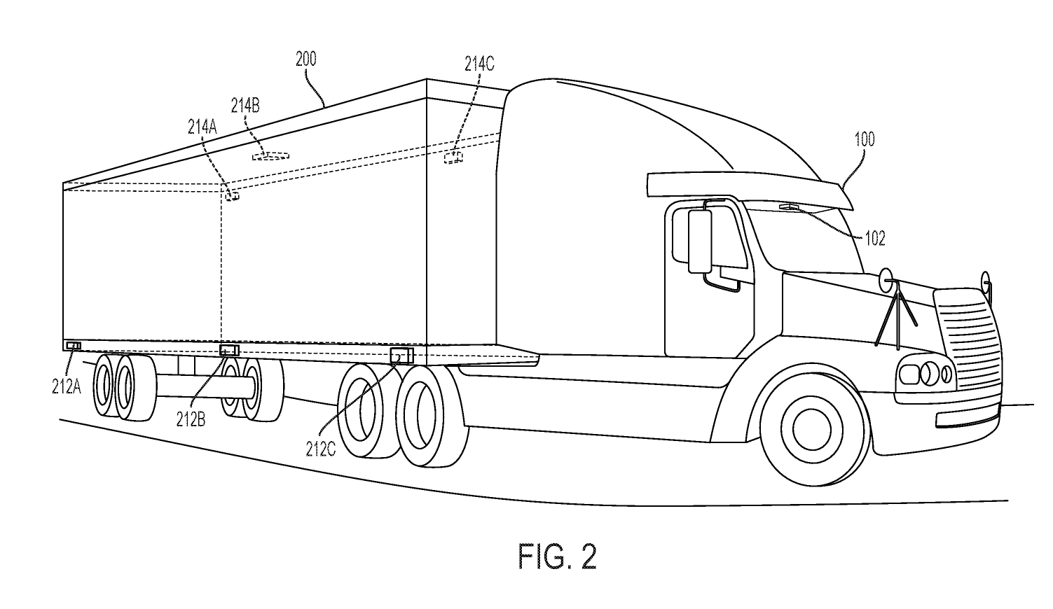

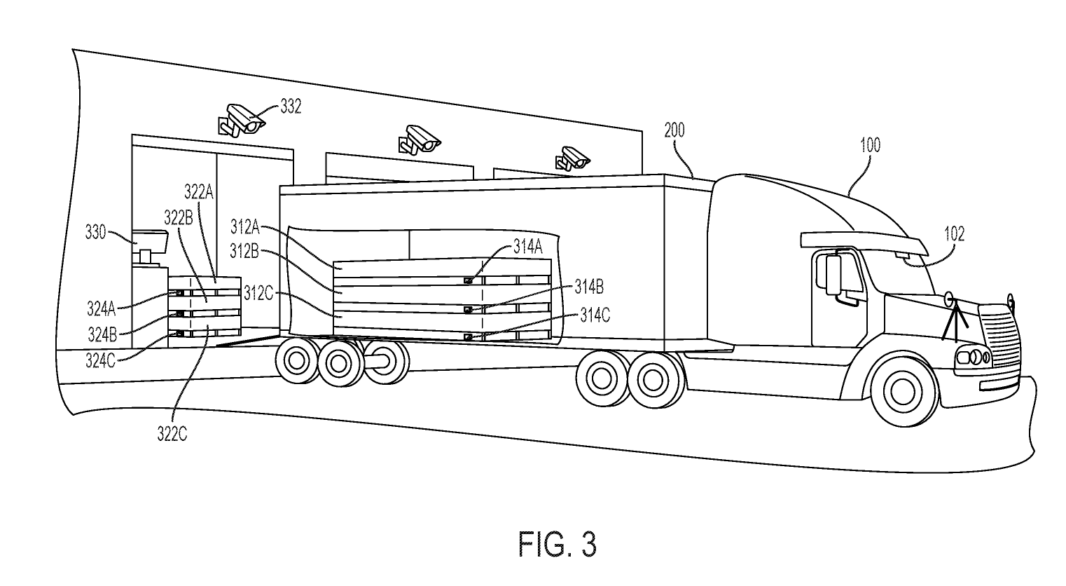

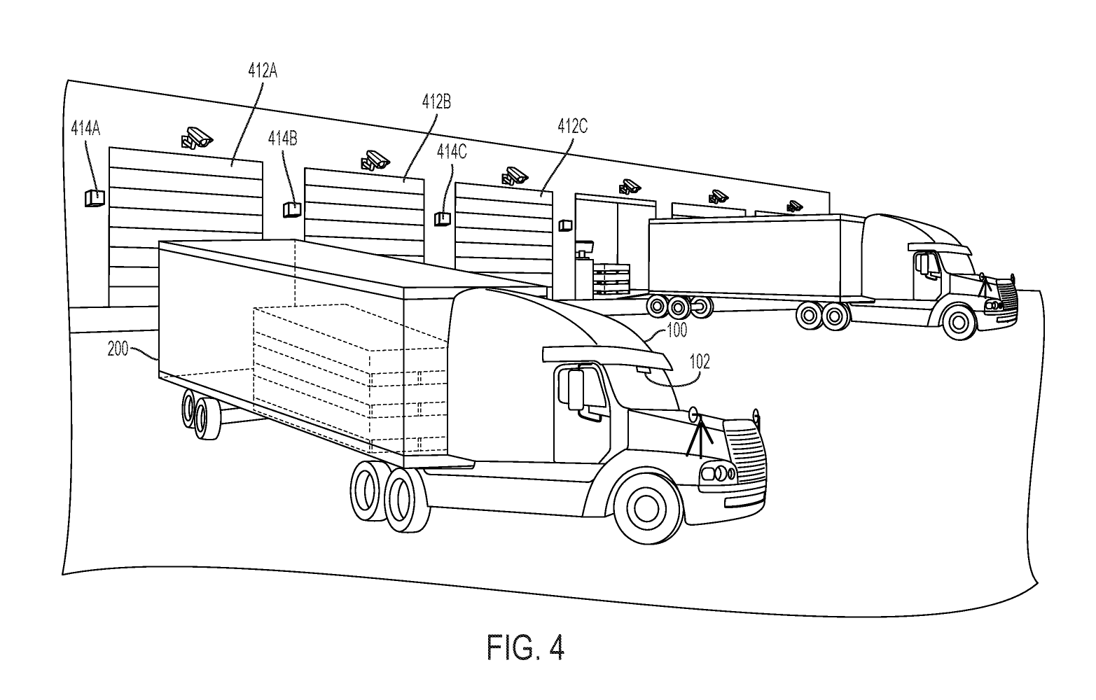

FIG. 1 shows one configuration of wireless devices that includes user mobile devices 112 and 114, the engine computer 122, the camera 124, and the tracking system 126. However, any combination of electronic devices may be used in combination with the vehicle gateway 102 of embodiments. For example, although FIG. 1 illustrates electronic devices in and around the truck cab, electronic devices may be anywhere in communications range. For example, devices may be in an attached or nearby truck trailer, as shown in FIG. 2, wherein a nearby truck trailer may be a truck trailer within short-range communications range of the vehicle 100. Communications with nearby beacons and gateways may allow, for example, a gateway to identify locations of missing or stolen trailers or cargo when passing within short-range communications range. Further, the vehicle gateway 102 may communicate with stationary gateways and electronic devices, such as beacons, sensors, devices, and gateways in a loading bay as shown in FIG. 3 and FIG. 4. The gateway 102 may also communicate with gateways on other vehicles. For example, a plurality of gateways installed on a plurality of vehicles may communicate with each other to form a mesh network allowing one of the gateways to communicate through other gateways when its long-range communications radio is not functioning correctly.

FIG. 2 is a perspective view of a vehicle illustrating an installed gateway for communicating with sensors in and around a tractor trailer attached to the vehicle according to one embodiment of the disclosure. The gateway 102 may be coupled to or integrated with an input device, such as a low-power RF radio for wireless communications, to communicate with electronic devices 212A, 212B, and 212C attached to a tractor trailer 200. The devices 212A-C may be, for example, sensors (e.g., GPS receivers) or cameras. The devices 212A-C may report loading of the cargo in the trailer or air pressure in tires of the trailer. The same input device may also be used to communicate with electronic devices 214A-C inside the tractor trailer. The devices 214A-C may be beacons attached to cargo that provide information about cargo carried by the tractor trailer or cameras mounted in the interior of the trailer. Example uses of devices attached to the frame and inside the trailer are provided below. The gateway 102 may collect information from the devices 212A-C and 214A-C. The information may be processed by the gateway 102 and used, for example, to assist in arranging cargo in the trailer and in verifying loading of correct cargo in the trailer.

FIG. 3 is a perspective view of a vehicle illustrating an installed gateway for communicating with electronic components in and around the vehicle and in and around a loading bay according to one embodiment of the disclosure. The gateway 102 may communicate with electronic devices outside the vehicle, such as in a loading bay, to facilitate management of cargo in the trailer. For example, cargo pallets 312A, 312B, and 312C inside of the trailer 200 may each have an attached electronic device 314A, 314B, and 314C, respectively, such as a beacon. The beacons 314A-C may transmit cargo identification information that includes an identifier for the attached cargo pallet. The beacon 314A-C may also transmit other information, such as contents of the cargo pallet. In some embodiments, the beacons 314A-C may be active devices that are continuously transmitting data. In other embodiments, the beacons 314A-C may be passive devices that only transmit information when interrogated, similar to RFID tags. Additional cargo pallets 322A, 322B, and 322C may be located inside the loading bay, with attached beacons 324A, 324B, and 324C, respectively. The beacons 324A-C may communicate with the gateway 102 directly. The beacons 324A-C may also communicate with a second gateway 330 inside the loading bay, which may relay information to the gateway 102. Additional electronic devices, inside or outside the trailer 200, may provide further information, such as to verify correct loading of cargo. For example, cameras 332 may capture images or video of the loading of cargo pallets 312A-C and/or 322A-C to provide visual confirmation to verify information from the beacons 322A-C and 324A-C. For example, a gateway 102 may determine if an approximate size of the pallet 312A matches a size of the cargo contents indicated by beacon 322A.

FIG. 4 is a perspective view of a vehicle illustrating an installed gateway for communicating with electronic components in cargo and around a loading bay or other nearby vehicles according to one embodiment of the disclosure. When a vehicle is moving, some electronic devices may enter and exit communications range of the gateway 102. For example, as a tractor trailer drives through a set of loading bays, the gateway 102 may establish communication with each of the electronic devices 414A, 414B, and 414C associated with loading bays 412A, 412B, and 412C, respectively. The gateway 102 may communicate with the electronic devices 414A-C to determine a correct loading bay. The gateway 102 may also communicate with the electronic devices 414A-C to determine if any of the loading bays 412A-C contain cargo that could be potentially hazardous if in close proximity to cargo carried in the trailer. As another example, a vehicle may drive through the loading bays with a gateway 102 to inventory the cargo in the loading bays 412A-C. This would allow for periodic updating of the location of cargo and the ability to find misplaced cargo by driving a vehicle through the loading bay. Alternatively or additionally, the tractor trailers may scan for missing cargo as they drive through the loading bay to pick up or drop-off cargo.

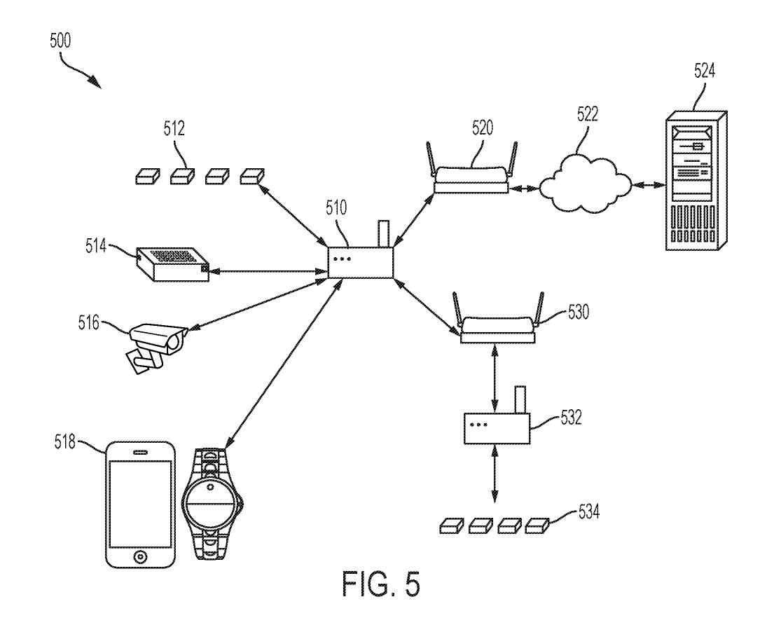

As described in the examples above, many combinations of electronic devices such as shown in FIG. 1, FIG. 2, FIG. 3, and FIG. 4 may be configured to operate with a vehicle gateway. An illustration of communications between the electronic devices is described in FIG. 5 without reference to any particular application. FIG. 5 is a block diagram illustrating communications paths around a vehicle gateway for communicating with electronic components according to one embodiment of the disclosure. A gateway 510 may be coupled to and/or include various input devices to accommodate communication with a variety of devices in different configurations. The gateway 510 may be programmed, such as through firmware or software, to perform a number of different functions involving the various electronic devices. Although certain trucking examples are described in FIG. 1, FIG. 2, FIG. 3, FIG. 4, and the examples below, the gateway 510 may be configured to perform many other functions. For example, rather than using the gateway 510 on a truck for cargo management, the gateway 510 may be installed in a passenger vehicle and used to assist a driver on a cross-country trip. Further, the gateway 510 need not be limited to land vehicles, but may also be used in other configurations, such as on boats and aircraft for tracking cargo.

The gateway 510 may be coupled to and/or include input devices for communicating with local electronic devices that are in or near the vehicle. For example, the gateway 510 may be configured with wireless or wired communication input devices to receive data from vehicle sensors 512, an engine computer 514, cameras 516, and/or mobile devices 518. The input devices configured to communicate with the devices 512, 514, 516, and/or 518 may include wired communications interfaces, such as Ethernet, OBDII, serial, or parallel interfaces, and/or wireless communications interfaces, such as Wi-Fi, Bluetooth, ZigBee, RFID, or NFC.

The gateway 510 may also be coupled to input devices, such as modem devices, for communicating with electronic devices away from the vehicle. For example, the gateway 510 may be coupled to a long-range communications modem 520 for communicating over a network 522, such as the Internet, with remote servers 524. The remote servers 524 may offer storage and/or processing capabilities that enhance the function of the gateway 510. As another example, the gateway 510 may be coupled to and/or include a short-range communications modem 530 for communicating with a second gateway 532. The second gateway 532 may be attached to a second vehicle and be configured to communicate with electronic devices 534 in or near the second vehicle. The gateway 510 may have access to raw data from the electronic devices 534 and/or receive processed data from the second gateway 532.

The vehicle gateway may be used in monitoring and optimizing the loading and unloading of a tractor trailer. For example, the trailer may include a plurality of load sensors placed along, for example, the bottom frame of the trailer. The vehicle gateway may receive data from these load sensors and use the data to determine whether existing cargo should be rearranged and/or to determine how to load or unload cargo from the trailer. In some embodiments, the vehicle gateway may attempt to distribute load evenly throughout the trailer, as measured by the load sensors. In other embodiments, the vehicle gateway may have other optimization criteria used to determine placement of cargo within the trailer. For example, the vehicle gateway may arrange cargo to place cargo being delivered first or needing prioritized access nearest the trailer doors. As the vehicle route is determined, these maximum weights may be identified for various portions of the route and the cargo may be organized in the trailer so as to meet the requirements of all states traversed by the vehicle's route. Further, in some embodiments, the vehicle gateway may use multiple optimization criteria to determine placement of cargo within the trailer. For example, the gateway may balance achieving ideal load distribution with a planned route of drop-off and pick-up locations. As another example, the gateway may allow for Less-Than-Truckload (LTL) shipments where new freight pieces will be added or removed along a vehicle's route.

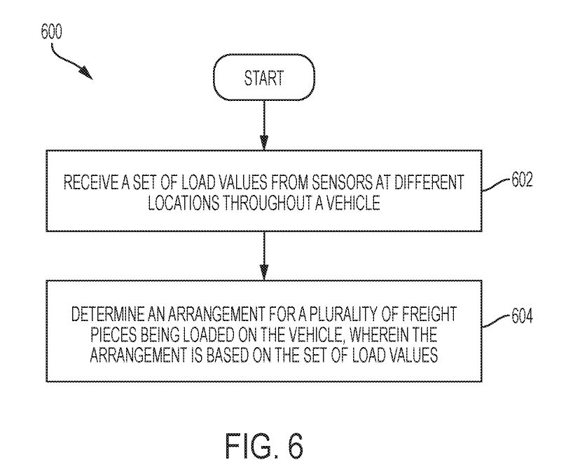

One method for a vehicle gateway to use load sensor data is described with reference to FIG. 6. FIG. 6 is a flow chart illustrating an example method for load balancing in a trailer with a vehicle gateway according to one embodiment of the disclosure. A method 600 may begin at block 602 with receiving a set of load values from sensors at different locations throughout a vehicle, such as from a tractor trailer. Then, at block 604, the gateway may determine an arrangement for a plurality of freight pieces being loaded on the vehicle based on the received set of load values. The determined arrangement may meet one or more preprogrammed or user-specified criteria or may be selected to optimize the arrangement for certain results. For example, in one embodiment, the arrangement may be selected to equally distribute the load throughout the trailer. The steps of receiving load values and determining an arrangement for the freight pieces may be performed multiple times, such as each time a freight piece is loaded onto or unloaded from the trailer, to allow continual revision of the arrangement. In some embodiments, the steps of 602 and 604 may be performed in real-time or near real-time during loading of the freight pieces or operation of the vehicle. For example, the determined arrangement may be displayed to a user through a user's mobile device that is communicating with the vehicle gateway. Loading equipment, such as a fork lift, may include a sensor that may measure the weight of freight pieces being loaded into the trailer. Freight pieces may refer, for example, to boxes, pallets, racks, other shipping containers, or other objects that may be carried on a trailer, such as cars, boats, trucks, and the like.

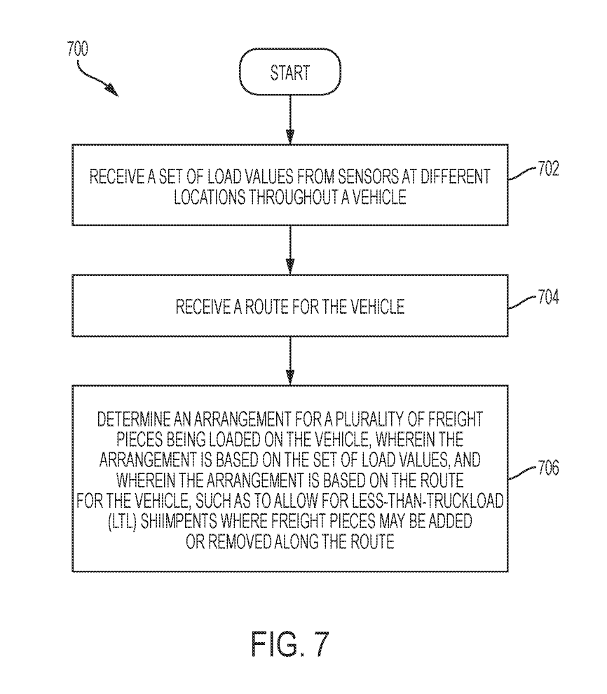

The freight pieces may also be arranged based on a known route of the vehicle and planned deliveries or pick-ups along the route. One example operation of a vehicle gateway using route information and load information is described with reference to FIG. 7. FIG. 7 is a flow chart illustrating an example method for load balancing in a trailer while taking into account vehicle route with drop-offs and pick-ups according to one embodiment of the disclosure. A method 700 may begin at block 702 with receiving a set of load values from sensors at different locations throughout a vehicle. At block 704, a route for the vehicle may be received. The route may be received, for example, through user input to a GPS device in the vehicle, through a mobile application on a user's mobile device, and/or through a remote server as an assigned route received at the vehicle gateway. Then, at block 706, an arrangement for loading the freight pieces may be determined, in which the arrangement is based on the received load values of block 702 and the route for the vehicle at block 704 to optimize for one or more criteria. In some embodiments, the loading of the freight pieces may be directed by the vehicle gateway, by transmitting loading instructions. For example, the loading instructions may be transmitted to a mobile device carried by a user on the loading dock or transmitting a beacon identifier to a fork lift on the loading dock for a next freight piece to be loaded. When the determined arrangement for the freight pieces takes into account the vehicle route, the arrangement may allow for Less-Than-Truckload (LTL) shipments where new freight pieces will be added or removed along the route. The method of FIG. 7 may be repeated to allow real-time or near real-time determination of arrangement of the freight pieces based on measured load. For example, blocks 702 and 706 may be repeated after each freight piece is loaded into the trailer.

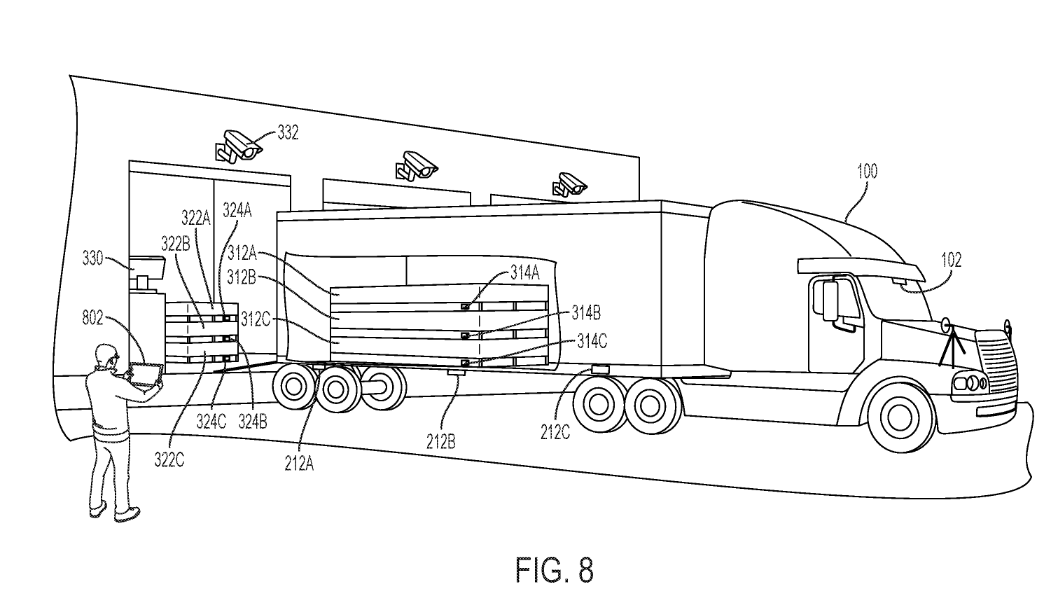

One example use of a vehicle gateway in loading freight pieces in a determined arrangement, such as determined from the methods of FIG. 6 and FIG. 7 is described with reference to FIG. 8. FIG. 8 is a perspective view of a vehicle illustrating an installed gateway for communicating with electronic components in and around the vehicle and in and around a loading bay according to one embodiment of the disclosure. The vehicle gateway 102 may be accessed by a user through a mobile device 802, or other computing device. The device 802 may display the determined arrangement for freight pieces 312A-C and 322A-C. The user of the mobile device 802 may then load, unload, or move freight pieces to arrive at the determined arrangement. In some embodiments, as the user moves the freight pieces 312A-C and 322A-C, the vehicle gateway 102 may receive new information from the load sensors that deviates from the expected load distribution, causing the determined arrangement to be updated, and that update provided to the user through the device 802.

In some embodiments, the vehicle gateway 102 may receive information for freight pieces being loaded onto the vehicle. For example, freight pieces 312A-C and 322A-C may have attached beacons 314A-C and 324A-C, respectively, that can communicate with the vehicle gateway 102. The attached beacons may be informational tags, such as RFID tags or other short-range communications devices with storage capability, that provide information for the freight pieces attached to the sensors. The information may be a type of cargo in the freight piece, a weight of the cargo in the freight piece, or the like. The attached beacons may also or alternatively actively measure the freight pieces to provide information for the freight pieces to the vehicle gateway 102. For example, the beacons may include load sensors integrated into a bottom of the freight pieces that measures a load of the freight piece. The vehicle gateway 102 may use the received information to assist in determining the arrangement for freight pieces in the vehicle. For example, when the information includes a load of the freight piece, the vehicle gateway may determine where in the trailer to place the freight piece to maintain a desired load distribution in the trailer. As another example, when the information includes a delivery address for the freight piece, the vehicle gateway may determine where in the trailer to place the freight piece to assist with unloading of the freight piece. As a further example, when the information includes a weight for the freight piece, the vehicle gateway may compute an overall total weight for the vehicle with the freight pieces loaded, and use that information for record keeping and/or optimizing operation of the vehicle engine. Any of these examples may be combined and implemented in a vehicle gateway.

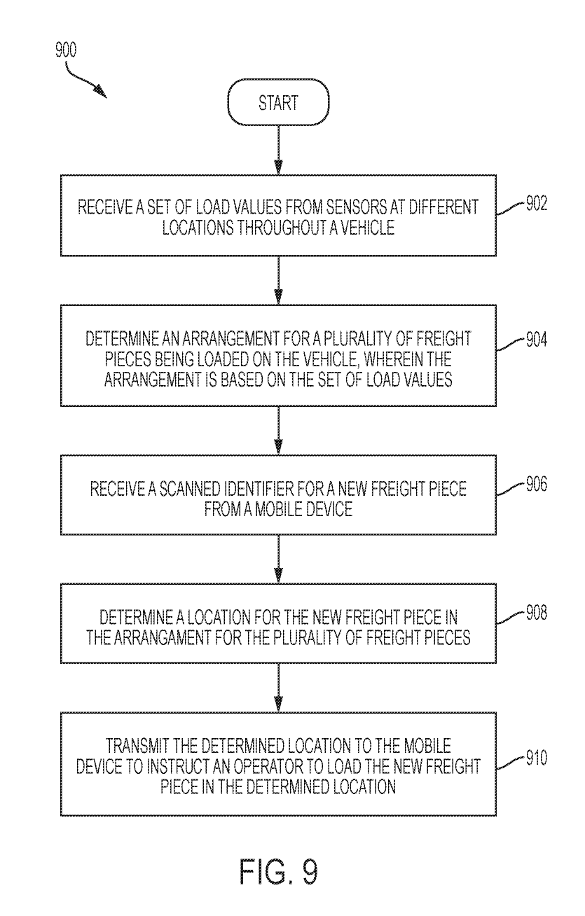

The mobile device 802 may provide information to the user for loading the freight pieces by receiving an indication of a freight piece being loaded and providing instructions for the loading of that freight pieces. One example method of this operation is described with reference to FIG. 9. FIG. 9 is a flow chart illustrating an example method of guiding a user in the loading of a trailer using an interface to the vehicle gateway according to one embodiment of the disclosure. A method 900 may begin at block 902 with receiving a set of load values from sensors at different locations throughout a vehicle. These load values may provide a current snapshot of loading within the vehicle. Next, at block 904, an arrangement for a new set of freight pieces may be determined. The arrangement of old and new freight pieces may be based on the load values received at block 902, such as by selecting an arrangement for the new fright to improve or maintain the current load distribution. At block 906, a scanned identifier for a new freight piece may be received from a mobile device. For example, the user may use the device 802 to scan a bar code or RFID tag on one of the new freight pieces, which is transmitted to the vehicle gateway. At block 908, a location for the scanned freight piece may be determined within the overall arrangement determined at block 904. At block 910, the vehicle gateway may transmit the determined location for the new freight piece to the mobile device to instruct the user to load the new freight piece in the determined location.

Some of the above examples describe a vehicle gateway that has a priori information regarding the freight pieces being loaded in the vehicle. In some embodiments, the information may be provided to the vehicle gateway as the freight pieces are being loaded, and the vehicle gateway may make a determination regarding location for the freight pieces within the vehicle as the information is received. The user may scan a barcode or RFID tag using the mobile device in the loading area as the freight piece is loaded onto the vehicle. Information regarding the freight piece may be obtained from the scan, or the scan used to obtain further information regarding the freight piece. That information may be forwarded to the vehicle gateway, which may then update the determined arrangement.

In some embodiments, additional sensors may be located throughout the vehicle and communicate with the vehicle gateway to provide information used in determining an arrangement of the freight pieces. For example, tire pressure sensors may communicate with the vehicle gateway to provide information regarding the tires. A determined arrangement of the freight pieces may take into account that information, such as by placing heavier loads over tires with higher pressures. As another example, cameras may be mounted on the vehicle and configured to capture images of the freight pieces as they are loaded into the vehicle. The images may be used to confirm whether the loaded freight pieces are the correct freight pieces and/or whether the freight pieces are loaded into the correct location indicated in the determined arrangement for the freight pieces. As a further example, sensors may be located at axel attachment points and/or on the trailer axels to provide further information for load balancing and determining arrangement of the freight pieces.

In some embodiments, information collected by the vehicle gateway regarding the freight pieces and/or the determined arrangement of the freight pieces may be used to adjust operating conditions of the vehicle. The operating conditions may be adjusted to improve ride, improve fuel efficiency, or the like. For example, the vehicle gateway may adjust an air bag suspension of the vehicle based on the determined arrangement. As another example, the vehicle gateway may adjust a firmware for the vehicle engine based on the determined arrangement and/or a total weight of the freight pieces.

The schematic flow chart diagrams of FIGS. 6, 7, and 9 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The operations described above as performed by a gateway, beacon, or electronic device may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuity may be configured as a general purpose processor capable of executing instructions contained in software. If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described as components in gateways, beacons, mobile devices, or electronic devices, aspects of the invention may be implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An information handling system, comprising:
a first plurality of sensors configured to monitor a load at a corresponding plurality of locations within an enclosed space of a vehicle; and
a gateway configured to attach to the vehicle and to communicate with the first plurality of sensors, wherein the gateway is configured to perform steps comprising:
receiving a first plurality of load values from the first plurality of sensors correspond to the plurality of locations; and
determining an arrangement for a plurality of freight pieces within the vehicle based, at least in part, on the received first plurality of load values.

2. The information handling system of claim 1, further comprising a plurality of beacons configured to provide cargo information of corresponding freight pieces of the plurality of freight pieces, wherein the gateway is further configured to perform steps comprising:
receiving cargo information for the corresponding freight pieces from the plurality of beacons,
wherein the step of determining the arrangement for the plurality of freight pieces is based, at least in part, on the received cargo information,
wherein the cargo information received from each of the second plurality of beacons comprises a weight of the corresponding freight pieces, and wherein the gateway is further configured to perform steps comprising determining a weight of the vehicle for the determined arrangement for the plurality of freight pieces.

3. The information handling system of claim 2, wherein the cargo information comprises a cargo identifier, and wherein the gateway is further configured to perform steps comprising receiving a cargo weight of the corresponding freight pieces using the cargo identifier.

4. The information handling system of claim 1, wherein the gateway is further configured to perform steps comprising:
receiving a route for the vehicle,
wherein the step of determining the arrangement for the plurality of freight pieces is based, at least in part, on the received route for the vehicle.

5. The information handling system of claim 4, wherein the step of determining the arrangement for the plurality of freight pieces is based, at least in part, on the received route to allow for Less-Than-Truckload (LTL) shipments where new freight pieces will be added or removed along the route.

6. The information handling system of claim 4, wherein the step of determining the arrangement for the plurality of freight pieces is based on jurisdictions traversed along the route.

7. The information handling system of claim 1, further comprising a second plurality of sensors configured to monitor air pressure in tires of the vehicle, wherein the gateway is configured to perform steps comprising receiving a first plurality of air pressure values from the second plurality of sensors corresponding to tires of the vehicle, and wherein the step of determining the arrangement for the plurality of freight pieces is based, at least in part, on the received first plurality of air pressure values.

8. The information handling system of claim 1, wherein the gateway is further configured to perform steps comprising:
receiving images of loading of the plurality of freight pieces; and
determining whether the plurality of freight pieces were loaded into the enclosed space according to the determined arrangement.

9. The information handling system of claim 1, wherein the gateway is configured to communicate with a computing device, wherein the gateway is configured to perform steps comprising:
receiving a scanned identifier for a new freight piece from the computing device;
determining a location for the new freight piece in the arrangement for the plurality of freight pieces within the vehicle; and
transmitting the determined location to the computing device.

10. The information handling system of claim 1, wherein the gateway is further configured to perform steps comprising adjusting an air bag suspension of the vehicle based, at least in part, on the determined arrangement for the plurality of freight pieces.

11. A method, comprising:
receiving, at a vehicle gateway, a first plurality of load values from a first plurality of sensors corresponding to a plurality of locations on a vehicle; and
determining, by the vehicle gateway, an arrangement for a plurality of freight pieces within the vehicle based, at least in part, on the received first plurality of load values.

12. The method of claim 11, further comprising receiving cargo information for the plurality of freight pieces from a plurality of beacons, wherein the step of determining the arrangement for the plurality of freight pieces is based, at least in part, on the received cargo information, wherein the cargo information received from each of the second plurality of beacons comprises a weight of each of the plurality of freight pieces, and wherein the method further comprises determining, by the vehicle gateway, a weight of the vehicle for the determined arrangement for the plurality of freight pieces.

13. The method of claim 11, further comprising:
receiving a route for the vehicle,
wherein the step of determining the arrangement for the plurality of freight pieces is based, at least in part, on the received route for the vehicle.

14. The method of claim 13, wherein the step of determining the arrangement for the plurality of freight pieces is based, at least in part, on the received route to allow for Less-Than-Truckload (LTL) shipments where new freight pieces will be added or removed along the route.

15. The method of claim 11, further comprising:
receiving a first plurality of air pressure values from a second plurality of sensors corresponding to tires of the vehicle,
wherein the step of determining the arrangement for the plurality of freight pieces is based, at least in part, on the received first plurality of air pressure values.

16. The method of claim 11, further comprising:
receiving images of loading of the plurality of freight pieces; and
determining whether the plurality of freight pieces were loaded into the enclosed space according to the determined arrangement.

17. The method of claim 11, further comprising:
receiving a scanned identifier for a new freight piece from a computing device;
determining a location for the new freight piece in the arrangement for the plurality of freight pieces within the vehicle; and
transmitting the determined location to the computing device.

18. The method of claim 11, adjusting an air bag suspension of the vehicle based, at least in part, on the determined arrangement for the plurality of freight pieces.

19. A computer program product comprising a computer readable medium comprising code to execute steps on a vehicle gateway, wherein the steps comprise:
receiving, at a vehicle gateway, a first plurality of load values from a first plurality of sensors corresponding to a plurality of locations on a vehicle; and
determining, by the vehicle gateway, an arrangement for a plurality of freight pieces within the vehicle based, at least in part, on the received first plurality of load values.

20. The computer program product of claim 19, wherein the medium further comprises code to execute steps comprising:
receiving a route for the vehicle,
wherein the step of determining the arrangement for the plurality of freight pieces is based, at least in part, on the received route for the vehicle,
wherein the step of determining the arrangement for the plurality of freight pieces is based, at least in part, on the received route to allow for Less-Than-Truckload (LTL) shipments where new freight pieces will be added or removed along the route.
